(19) United States
(12) Patent Application Publication
(10) Pub. No.: US 2011/0138196 A1
(43) Pub. Date: Jun. 9, 2011

(54) ROUTER COLLABORATION

(76) Inventors: Phillip T. Magnuson, Boise, ID (US); David Alan Johnson, Boise, ID (US)

(21) Appl. No.: 12/959,003

(22) Filed: Dec. 2, 2010

Related U.S. Application Data
(60) Provisional application No. 61/266,949, filed on Dec. 4, 2009.

(51) Int. Cl. G06F 1/26; G06F 15/16

(52) U.S. Cl. 713/300; 709/227

(57) ABSTRACT

A router system is disclosed. The router system comprises a wireless router and a cradle comprising a router interface configured to receive the router. One or more connections are positioned at the router interface for communicating with the router. Methods and systems for communicating between a router and the internet are also disclosed.

The present disclosure claims priority to U.S. Provisional Application No. 61/266,949, filed on Dec. 4, 2009, the disclosure of which is hereby incorporated by reference in its entirety.

### BACKGROUND

Routers allow client devices in a local area network (LAN) to access a wide area network (WAN). Connections between client devices and the router may be wired or wireless. Similarly, connections between the router and the Wide Area Network may be wired or wireless. Wireless connections to the WAN may be through a cellular network.

Portable, wireless routers are well known in the art. Such routers can connect to the internet using a data exchanger. The router can provide a wireless link to local client devices. In addition, the router may provide a wireless link to an internet service provider. However, wireless links to internet service providers can sometimes provide relatively slow data transfer and/or be costly to use.

In addition, wireless routers may suffer from poor signal strength between the router and the client devices and/or the internet service provider. Further, the router may run on batteries that are rechargeable, or need to operate continuously for a period of time that is longer than some batteries will allow.

The present disclosure is directed to addressing on or more of the problems discussed above.

### SUMMARY

An embodiment of the present disclosure is direct to a method for communicating between a router and the internet. The method comprises establishing a first remote link between the router and an internet service provider using a primary data exchanger. A second remote link is established between the router and an internet service provider using an alternate data exchanger. The alternate data exchanger is embedded in a cradle configured to receive the router.

Another embodiment of the present disclosure is directed to a router system. The router system comprises a wireless router comprising a data exchanger interface and a cradle configured to hold the wireless router. The cradle comprises an alternate data exchanger embedded in the cradle. The data exchanger interface is configured to communicate with the alternate data exchanger when the router is positioned in the cradle.

Yet another embodiment of the present disclosure is directed to a router cradle. The router cradle comprises a router interface configured to receive a router. One or more connections are positioned at the router interface for communicating with the router.

Another embodiment of the present disclosure is directed to a router system. The router system comprises a wireless router and a cradle comprising a router interface configured to receive the router. One or more connections are positioned at the router interface for communicating with the router.

Still another embodiment of the present disclosure is direct to a method for communicating between a router and the internet. The method comprises establishing a first remote link between the router and an internet service provider using a primary data exchanger. A second remote link is established between the router and an internet service provider using an alternate data exchanger. The alternate data exchanger is embedded in a wireless gateway. The router is configured to automatically establish the second remote link when in communication range of the wireless gateway.

### DESCRIPTION OF THE DRAWINGS

FIGS. 1 and 2 are block diagrams of systems comprising a router, according to embodiments of the present disclosure.

FIG. 3 is a schematic drawing illustrating a router system comprising a router and a cradle, according to an embodiment of the present disclosure.

FIG. 4 is a schematic drawing illustrating a router system comprising a router and a wireless gateway, according to an embodiment of the present disclosure.

FIGS. 5 and 6 are block diagrams of routers, according to embodiments of the present disclosure.

FIG. 7 is a block diagram of a router system comprising a cradle, according to an embodiment of the present disclosure.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the disclosure as defined by the appended claims.

### DETAILED DESCRIPTION

Embodiments of the present disclosure allow a user to connect to the internet using a device such as an internet enabled cellular telephone, wireless modem or other cellular data access device. With a router, multiple users of computing devices, such as lap top computers, desktop computers, and personal digital assistants (PDAs), can access the internet simultaneously through the data capabilities of the cellular data access device. The combination of the router and the cellular data access device can provide an internet-connected local wireless network anywhere that there is cellular data coverage.

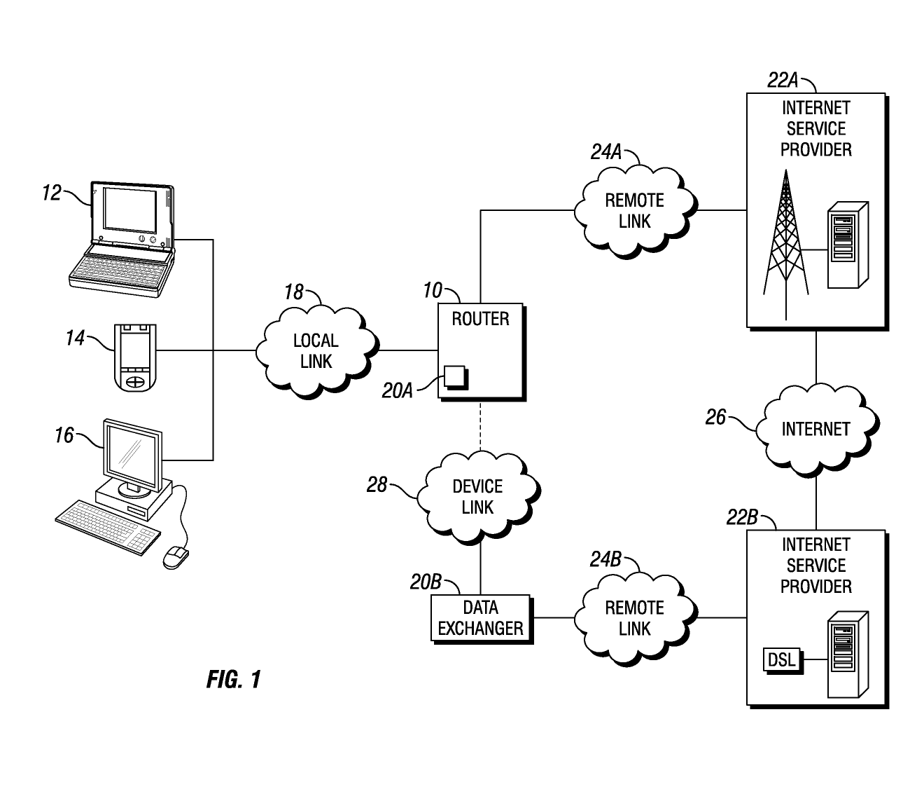

FIG. 1 illustrates exemplary environment 1 in which various embodiments of the present disclosure may be implemented. Environment 1 includes router 10, client devices 12, 14, and 16 and local link 18. Router 10, discussed in more detail later, represents generally a device capable of routing network communications between client devices 12, 14, and 16 and internet 26 via a data exchanger 20A. Client devices 12, 14, and 16 represent generally any computing devices capable of communicating with router 10.

Local link 18 interconnects router 10 and client devices 12, 14, 16. Local link 18 represents generally a cable, wireless, or remote link via a telecommunication link, an infrared link, a radio frequency link, or any other connector or system that provides electronic communication between devices 10, 12, 14, and 16. In FIG. 1, the path followed by link 18 between devices 10, 12, 14, and 16 represents the logical communication path between these devices, not necessarily the physical path between the devices. Devices 10, 12, 14, and 16 can be connected at any point and the appropriate communication path established logically between the devices.

Data exchanger 20A represents generally any combination of hardware and/or programming that can be utilized by router 10 to connect to a remote network such as the internet. In the example of FIG. 1, the data exchanger 20A and router 10 are incorporated within the same device and can be connected, for example, by using internal connections. In an embodiment, the data exchanger may take the form of a separate device card that can be inserted into a slot provided by router 10, or otherwise connected to the router 10 through an I/O port. Alternatively, the data exchanger may be fully integrated into router 10.

FIG. 2 illustrates another embodiment that is similar to FIG. 1, except that data exchanger 20A is separate from the router 10. For example, the data exchanger 20A can be an internet enabled cellular telephone. In the embodiment illustrated in FIG. 2, device link 28 interconnects router 10 and data exchanger 20A. Device link 28 represents generally any combination of a cable, wireless, or remote connection via a telecommunication link, an infrared link, a radio frequency link, or any other connector or system that provides electronic communication between devices 10 and 20A. As examples, device link 28 may incorporate a physical connection such as a USB cable or direct connection between USB connectors, or radio waves carrying Bluetooth communications.

The data exchangers 20A employed in the embodiments of the present disclosure can be any suitable type of data exchanger that will provide the desired connection to the internet. Examples of data exchangers include but are not limited to DSL modems, cable modems and cellular data modems.

Referring again to FIG. 1, service provider 22A represents generally any infrastructure configured to provide internet related data services to subscribers such as an owner of data exchanger 20A. For example, where data exchanger 20A is an internet enabled cellular telephone or cellular modem, service provider 22A may be a cellular telephone service provider capable of providing voice and data services to subscribers allowing access to internet 26. Where data exchanger 20A is a DSL or cable modem, service provider 22 may be a more traditional internet service provider (ISP) providing data access to internet 26 through wired means.

Remote link 24 interconnects data exchanger 20A and service provider 22A and represents generally any combination of a cable, wireless, or remote connection via a telecommunication link, an infrared link, a radio frequency link, or any other connector or system that provides electronic communication between data exchanger 20A and service provider 22A. Remote link 24A may represent an intranet, an internet, or a combination of both.

As shown in FIG. 1, the router 10 provides a local link 18 so that client devices 12, 14, 16 can communicate with the internet 26 via remote link 24A. If the remote link 24A is a wireless radio connection, then the router 10 may be easily moved and used by client devices 12, 14, 16 in various locations, or while in motion.

However, in some situations, communication through an alternate remote link would be preferable. For example, when a router 10 is in use and there is an alternative remote link available, the alternative remote link may provide faster data transmission rates or less expensive transmission, or have some other preferential aspect of use. It would be advantageous if the router 10 could use the alternate remote link when the alternate remote link is available and preferred.

As shown in FIGS. 1 and 2, in order to provide connections to alternate remote links, router 10 has an alternate device link 28 that provides a connection to an alternate data exchanger 20B, according to an embodiment of the present disclosure. This alternate data exchanger 20B works through an alternate remote link 24B, and alternate service provider 22B to provide access to the internet 26.

In an embodiment, when alternate data exchanger 20B is not available, then router 10 can communicate with the internet 26 through the primary remote link 24A. However when alternate data exchanger 20B is available, router 10 may use alternate device link 28 to access the internet 26.

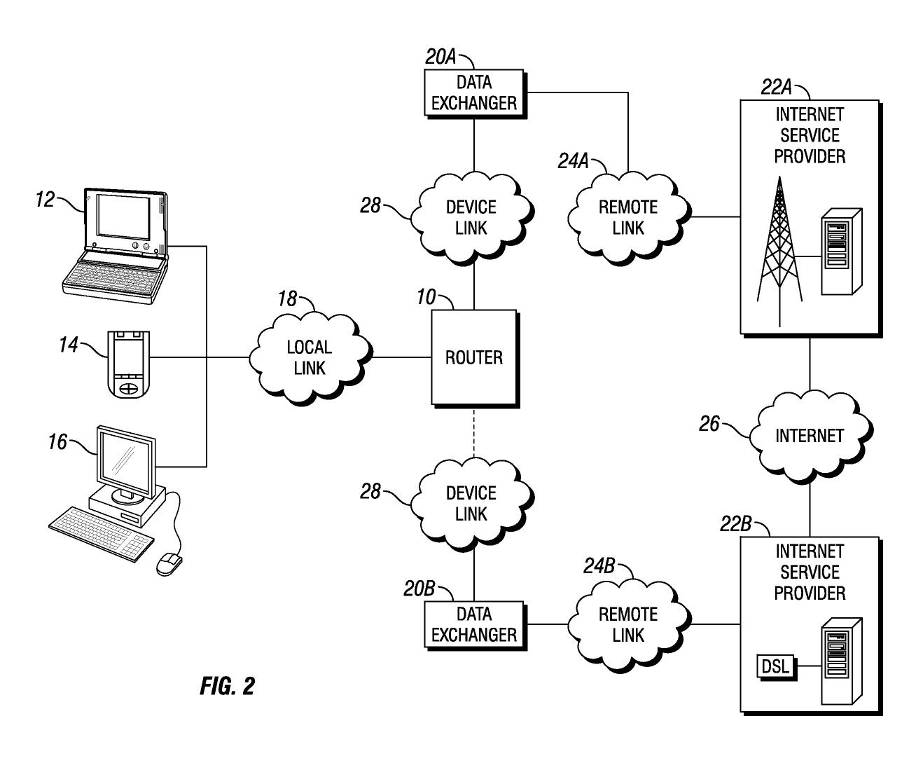

For example, as illustrated in FIG. 3, the alternate data exchanger 20B may be embedded in a cradle 174. When router 10 is placed in the cradle, a data connection can be made between the router 10 and the cradle 174. That connection can provide the device link 28, allowing the router 10 to communicate with the alternate data exchanger 20B. The cradle 174 can also include a remote link 24B, which in this example, is a wired connection to a wall jack 172 that provides wired connection to a wired service provider 22B. For example, this may be a DSL or a cable internet service provider.

In an embodiment, client devices 12, 14, 16 can remain connected to the router 10 through the local link 18 when router 10 switches between using data exchanger 20A and data exchanger 20B, and can thus still have access to the internet 26. Thus, if desired, access to the internet for the client devices 12, 14, 16 can remain constant, or substantially constant, whether the router 10 uses the primary remote link 24A or the alternate remote link 24B, or a combination of the primary and alternate remote links 24A, 24B.

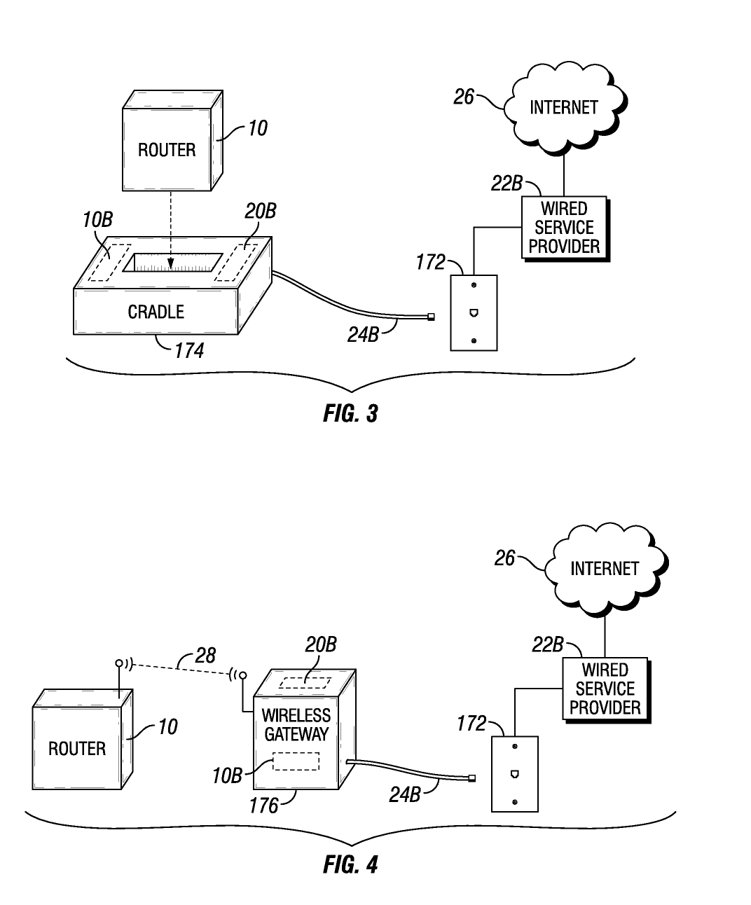

In another example configuration, as shown in FIG. 4, the router 10 may communicate wirelessly with a wireless gateway 176. The router 10 can behave as a client or peer to the wireless gateway 176. The wireless gateway 176 has an embedded data exchanger 20B and communicates with the internet 26 in a manner comparable to the cradle 174, as shown in FIG. 3 and described above. In an embodiment, the router 10 may be within communication range of the wireless gateway 176, and not in physical contact with the wireless gateway 176. The router 10 and the wireless gateway 176 may be preconfigured to establish a secure connection when router 10 and wireless gateway 176 are within range of communication.

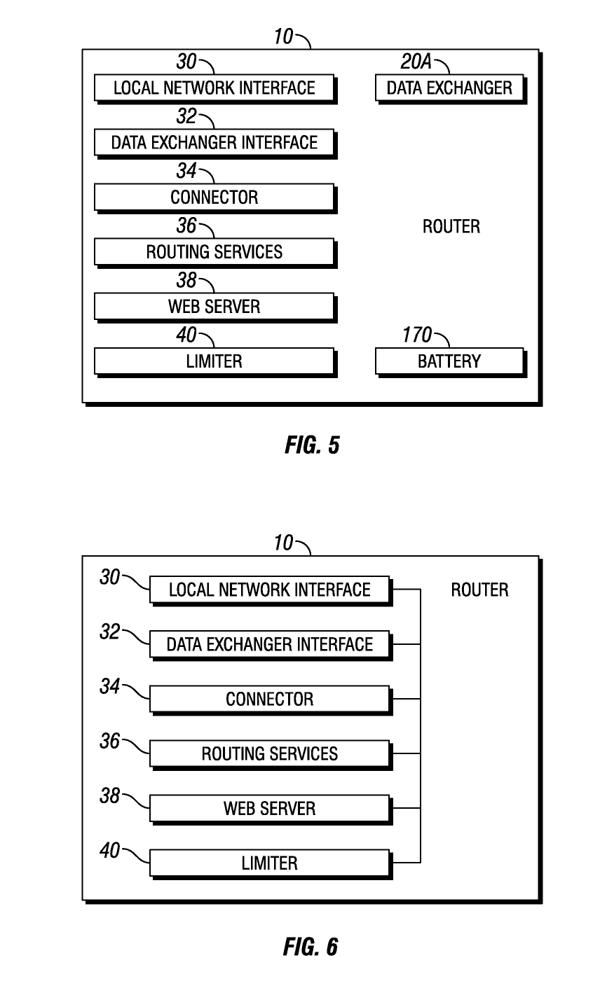

FIG. 5 is a block diagram illustrating exemplary physical and logical components of router 10, according to an embodiment of the present disclosure. As described above, router 10 represents generally any combination of hardware and/or programming capable functioning as a router for directing network communications between client devices on the local network, or between client devices and the internet via a data exchanger such as an internet enabled cellular telephone, cellular modem, DSL modem, or cable modem.

In the example of FIG. 5, router 10 includes local network interface 30 and data exchanger interface 32. Local network interface 30 represents generally any combination of hardware and/or program instructions capable of supplying a communication interface between router 10 and client devices 12, 14, and 16 shown in FIGS. 1 and 2.

Data exchanger interface 32 represents any combination of hardware and/or programming enabling data to be communicated between router 10 and a data exchanger 20A and/or 20B shown in FIGS. 1 and 2.

For example, interfaces 30 and 32 may include a transceiver operable to exchange network communications utilizing a wireless protocol such as ultrawideband (UWB), Bluetooth, or 802.11. Alternatively, interfaces 30 and 32 may include physical ports or other physical connection points enabling wired communication.

In an embodiment, as illustrated in FIG. 5, router 10 can also include an embedded data exchanger 20 in addition to the data exchanger interface 32. As shown in FIG. 1, data exchanger 20 allows router 10 to connect directly to ISP 22A via remote link 24A, as opposed to employing a separate data exchanger device. In the case of a data exchanger being embedded in router 10, router 10 can include a data exchanger interface such as, for example, a slot for a device card, such as a cellular modem, or the like, which allows communication with the embedded data exchanger. Alternatively, the embedded data exchanger can be fully integrated into the router, in which case the data exchanger interface may be replaced with internal device connections.

In an embodiment, router 10 can also include router services 36 and web server 38. Routing services 36 represents generally any combination of hardware and/or programming for routing network communication received through network interface 30 to be transmitted by data exchanger 20 to internet 26. Routing services 36 can also be responsible for routing inbound network communications received from internet 26 and directed via network interface 30 to a specified client device 12, 14, or 16. Outbound and inbound network communications, for example can be IP (internet protocol) packets directed to a target on internet 26 or to a particular network device 12, 14, or 16 on a local area network.

Web server 38 represents generally any combination of hardware and/or programming capable of serving interfaces such as web pages to client devices 12, 14, and 16. Such web pages may include web pages that when displayed by a network device allows a user to provide or otherwise select settings related to the operation of router 10.

Router 10 can optionally include a connector 34. Connector 34 represents generally any combination of hardware and/or programming for sending a signal to data exchangers 20A, 20B to establish a data connection with service providers 22A, 22B, so that access can be made to internet 26. For example, where a data exchanger 20A or 20B is a cellular telephone, connector 34 may send a signal causing the cellular telephone to establish a data link with service provider 22A or 22B. In an embodiment, the router 10 does not include a connector 34. In an embodiment, the hardware and/or programming for establishing a data connection with a service provider is included in, for example, a cellular modem that is employed as the data exchanger 20, which may be incorporated into router 10, as described above.

The router can optionally include a limiter 40. Limiter 40 represents generally any combination of hardware and/or programming capable of distinguishing among the users of devices such as client devices 12, 14, and 16, and applying different internet access rules for different users. For example, certain internet access rules may apply to the owner of router 10. In this context, the term owner refers to an individual or entity that is a subscriber with respect to a service provider such as service provider 22 shown in FIGS. 1 and 2. The owner typically has physical possession or otherwise has control of router 10. Other internet access rules can apply to users authorized by the owner. Yet other internet access rules apply to anonymous users. Where network interface 30 provides for a wireless connection with client devices, a user of a particular client device might not be known by the owner. As such, internet access rules for such users may be quite limiting. The limiter 40 and operation thereof are discussed in greater detail in U.S. patent application Ser. No. 11/673,956, filed Feb. 12, 2007, in the name of Pat Sewall, et al., the disclosure of which is hereby incorporated by reference in its entirety.

In an embodiment, router 10 may include a battery 170 or other form of self contained source of power to provide electrical power for the router 10 to function.

In an embodiment, one or more of the functions shown in FIGS. 5 and 6 may not be included. For example, router 10 can include a local network interface 30, a data exchanger interface 32, a connector 34, routing services 36, a web server 38 and a data exchanger 20, but not a limiter 40. As shown in FIGS. 2 and 6, and described above, router 10 may not have an embedded or enclosed data exchanger 20, but instead may employ an external data exchanger 20 that is connected to the router through a device link 28. Device link 28 may be any suitable link, such as a cable, or a direct physical connection between the data exchanger 20 and the router 10, or a form of wireless communication.

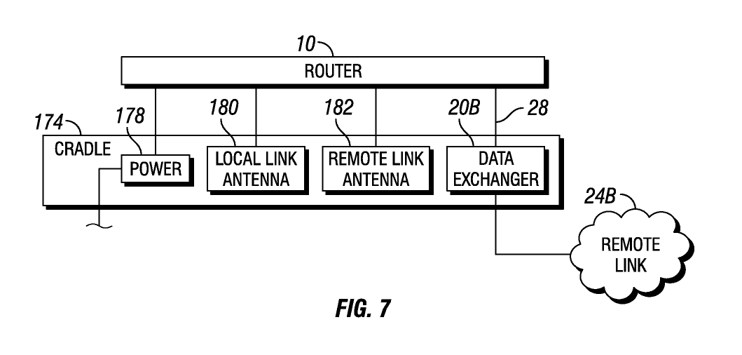

In an embodiment, as shown in FIG. 7, cradle 174 may provide functions in addition to those already described above. As mentioned above, the router 10 and cradle 174 can be configured so that when router 10 is placed into the cradle 174, a connection is made between the cradle 174 and the router 10, thereby connecting the router 10 to the alternate data exchanger 20B. In addition to the connection between the router 10 and the alternate data exchanger 20B, there may also be a connection to a power source 178, which provides power to operate the router 10 and/or to recharge the battery 170 located in the router 10. The cradle 174 may also be outfitted with a local link antenna 180 and a remote link antenna 182. These antennas 180, 182 may substitute for, or work in concert with, antennas embedded in the router 10, or in the device link 28 attached to or embedded in the router 10, in order to increase the signal strength of the local link 18 and the remote link 24. In an embodiment, the benefits, such as increased signal strength, connection to a power source, and/or connection to an alternate data exchanger can occur simply by placing the router 10 in the cradle 174. The client devices may be unaware of any change, and no change in configuration of the client devices is generally performed.

In yet another alternative configuration, the cradle 174 may contain one or more of the features shown in FIG. 7 in any combination. For example, the cradle 174 may comprise all of the features shown in FIG. 7, with the exception that cradle 174 does not contain data exchanger 20B or employ the associated remote link 24B. In this situation, the cradle 174 provides no alternative connection to the internet 26. However, when the router 10 is docked in the cradle 174, the battery 170 is recharged, the router 10 can operate indefinitely from line power, and the signal strength of the local link 18 or the remote link 24A, or both, is improved through the use of the local link antenna 180 and the remote link antenna 182 embedded or otherwise attached to the cradle 174. In yet another embodiment, the cradle comprises the power source and antennas 180 and 182, but instead of comprising an embedded data exchanger, the cradle provides a wireless or wired connection to a nearby home router (not shown) and/or data exchanger.

Referring to FIGS. 3 and 4, cradle 174 or wireless gateway 176 may optionally comprise a wired or wireless router 10B. This embodiment allows cradle 174 or wireless gateway 176 to perform typical wireless router functions for other client devices, whether or not the router 10 is connected to the cradle 174 or wireless gateway 176. Router 10B is shown in FIGS. 3 and 4 as being separate from data exchanger 20B in the cradle 174 and wireless gateway 176. In an alternate embodiment, router 10B can be embedded together with data exchanger 20B in cradle 174 or wireless gateway 176. One of ordinary skill in the art would readily be able to embed a router 10B in a cradle or wireless gateway.

The schematic diagrams of the figures illustrate exemplary environments in which embodiments of the present disclosure may be implemented. Implementation, however, is not limited to these environments. The diagrams of the figures show the architecture, functionality, and operation of various embodiments of the present disclosure. A number of the blocks are defined as programs. Each of those blocks may represent in whole or in part a module, segment, or portion of code that comprises one or more executable instructions to implement the specified logical function(s). Each block may represent a circuit or a number of interconnected circuits to implement the specified logical function(s).

Also, the present disclosure can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

What is claimed is:

1. A method for communicating between a router and the internet, the method comprising:
establishing a first remote link between the router and an internet service provider using a primary data exchanger; and
establishing a second remote link between the router and an internet service provider using an alternate data exchanger, the alternate data exchanger being embedded in a cradle configured to receive the router.

2. The method of claim 1, wherein the first remote link is established when the alternate data exchanger is not available.

3. The method of claim 1, wherein the primary data exchanger is embedded in the router.

4. The method of claim 3, wherein the router further comprises a data exchanger interface, the router communicating with the alternate data exchanger through the data exchanger interface.

5. The method of claim 1, wherein the second remote link is automatically established when the router is positioned in the cradle.

6. The method of claim 5, wherein the router comprises a battery, and wherein the cradle comprises a power source that charges the battery.

7. A router system, comprising:
(a) a wireless router comprising a data exchanger interface; and
(b) a cradle configured to hold the wireless router, the cradle comprising an alternate data exchanger embedded in the cradle, the data exchanger interface configured to communicate with the alternate data exchanger when the router is positioned in the cradle.

8. The router system of claim 7, wherein the router further comprises a primary data exchanger embedded in the router.

9. The router system of claim 8, wherein the primary data exchanger is configured to provide a wireless remote link to an internet service provider.

10. The router system of claim 8, wherein the primary data exchanger is a cellular modem.

11. The router system of claim 7, wherein the cradle comprises a local link antenna.

12. The router system of claim 7, wherein the cradle comprises a remote link antenna.

13. The router system of claim 7, wherein the router comprises a battery, and wherein the cradle comprises a power source that charges the battery.

14. The router system of claim 7, further comprising a router embedded in the cradle.

15. A router cradle, comprising:
a router interface configured to receive a router; and
one or more connections positioned at the router interface for communicating with the router.

16. The cradle of claim 15, further comprising a data exchanger embedded in the cradle.

17. The cradle of claim 15, further comprising a local link antenna.

18. The cradle of claim 15, further comprising a remote link antenna.

19. The cradle of claim 15, further comprising a connection to a power source, the connection configured to provide power to a router received in the router interface.

20. The cradle of claim 15, further comprising a router embedded in the cradle.

21. The cradle of claim 15, further configured to provide a wireless or wired connection to a second router.

22. A router system, comprising:
(a) a wireless router; and
(b) a cradle comprising a router interface configured to receive the router and
one or more connections positioned at the router interface for communicating with the router.

23. The system of claim 22, wherein the cradle further comprises a data exchanger embedded in the cradle.

24. The system of claim 22, wherein the cradle further comprises a local link antenna.

25. The system of claim 22, wherein the cradle further comprises a remote link antenna.

26. The system of claim 22, wherein the cradle further comprises a connection to a power source, the connection configured to provide power to the router when it is received in the router interface.

27. The system of claim 22, wherein the cradle further comprises a router embedded in the cradle.

28. A method for communicating between a router and the internet, the method comprising:
establishing a first remote link between the router and an internet service provider using a primary data exchanger;
and establishing a second remote link between the router and an internet service provider using an alternate data exchanger, the alternate data exchanger being embedded in a wireless gateway, the router being configured to automatically establish the second remote link when in communication range of the wireless gateway.

29. The method of claim 28, wherein the wireless gateway comprises a router.
